(19) United States
(12) Patent Application Publication
(10) Pub. No.: US 2018/0048558 A1
(43) Pub. Date: Feb. 15, 2018

(54) OPTIMIZING TRAFFIC IN A PACKET CORE NETWORK

(71) Applicant: CISCO TECHNOLOGY, INC., San Jose, CA (US)

(72) Inventors: David Lake, Crawley (GB); Mark Ian Rankin, Woodridge (GB)

(73) Assignee: CISCO TECHNOLOGY, INC., San Jose, CA (US)

(21) Appl. No.: 15/233,674

(22) Filed: Aug. 10, 2016

(51) Int. Cl. H04L 12/721; H04L 12/46; H04L 12/741

(52) U.S. Cl. CPC H04L 45/12; H04L 45/745; H04L 12/4633

(57) ABSTRACT

In an example, there is disclosed a method of operating a long-term evolution (LTE) network device, including: communicatively coupling to a public data network gateway (PGW); providing an LTE function; receiving an incoming packet; looking up a destination of the incoming packet on a tunneling table including a tunneling endpoint identifier (TEID) and an internet protocol (IP) address; determining that the destination of the incoming packet is reachable via a route shorter than traversing the PGW; and routing the packet via the shorter route, comprising cutting through a tunnel for the packet. There is also disclosed an apparatus and a computer-readable medium for performing the method.

### FIELD OF THE SPECIFICATION

This disclosure relates in general to the field of wireless communication, and more particularly, though not exclusively to, a system and method for optimizing traffic in a packet core network.

### BACKGROUND

The Third-Generation Partnership Project (3GPP) is an organization that propagates wireless telecommunication standards and promotes their adoption. 3GPP has provided useful standards such as global system for mobile communication (GSM), enhanced data rates for GSM evolution (EDGE), code division multiple access (CDMA), universal mobile telecommunication system (UMTS), and long-term evolution (LTE).

Certain of these standards provide for a base station such as a NodeB, evolved node B (eNodeB), femtocell, home eNodeB (HeNB), or similar to operate one or more carriers on a defined UMTS Terrestrial Radio Access (UTRA) Absolute Radio Frequency Number (UARFCN).

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a network-level diagram of a mobile network, such as a long-term evolution (LTE) network according to one or more examples of the present specification.

FIG. 2 is a network-level diagram of an enterprise network according to one or more examples of the present specification.

FIG. 3 is a block diagram of a user equipment (UE)-class device according to one or more examples of the present specification.

FIG. 4 is a block diagram of a server-class device according to one or more examples of the present specification.

FIG. 5 is a block diagram of tunneling according to one or more examples of the present specification.

FIG. 6 is a block diagram of a packet flow according to one or more examples of the present specification.

FIG. 7 is a block diagram of optimized packet flow according to one or more examples of the present specification.

FIG. 8 is a flow chart of a flow optimization method according to one or more examples of the present specification.

### SUMMARY

In an example, there is disclosed a method of operating a long-term evolution (LTE) network device, including: communicatively coupling to a public data network gateway (PGW); providing an LTE function; receiving an incoming packet; looking up a destination of the incoming packet on a tunneling table including a tunneling endpoint identifier (TEID) and an internet protocol (IP) address; determining that the destination of the incoming packet is reachable via a route shorter than traversing the PGW; and routing the packet via the shorter route, comprising cutting through a tunnel for the packet. There is also disclosed an apparatus and a computer-readable medium for performing the method.

### EMBODIMENTS OF THE DISCLOSURE

The following disclosure provides many different embodiments, or examples, for implementing different features of the present disclosure.

In a 3GPP LTE network, IP data generally flows between end user “user equipment” (UE) devices through an “anchor point,” the PDN gateway (PGW). The traffic flow in the evolved packet core (EPC) is between the eNodeB (eNB) and the serving gateway (SGW) using a GTP encapsulation, then to the Anchor Point at the P-GW using a GPRS tunneling protocol (GTP) tunnel. In the case of an external IP devices (e.g. content cache) the traffic ingresses and egresses the EPC using the SGi interface.

Where two UE devices are communicating, the IP addresses of the UEs only have mutual reachability at the PGW. The same is true of a device on the SGi interface. The GTP parameters are allocated to the eNB as part of the attachment process of the UE, each GTP session being given a tunneling endpoint identifier (TEID) for the duration of the attachment.

Thus, two users may be standing literally next to each other, with one streaming data to the other, but the path those data travel may be many miles long. If the data include multimedia data, the users may immediately notice an inefficiency: despite the users' physical proximity, the stream between their devices is delayed by the long path with many hops between the two devices.

As the typical EPC consists of a number of geographically dispersed SGWs and a lower number of centralized PGWs, all traffic routes through the central core of the network, regardless of physical proximity. This creates an ease of mobility as the PGW and the GTP tunnel forms the lowest common connection point between two devices irrespective of whether they are attached to the same eNB, same SGW or SGi, but it creates suboptimal routing of media packets which can lead to high utilization of core network links.

This specification discloses a mechanism whereby a media session may be optimally transported while retaining the mobility of the GTP mechanism. In an example, when a mobile device attaches each bearer to the EPC, the user data session is connected, via the S1-U, to the SGW, thence over S5 to the PGW. These interfaces both operate as tunnels with a GTP header over UDP/IP.

The ID associated with the tunnel endpoint is referred to as a TEID and allows determination of a path through the EPC. Once connected to the PGW, the device is given an IP address from an appropriate pool. Irrespective of which eNB or SGW the UE moves to, the same IP address may be used, but new tunnels between the eNB and SGW and/or between SGW and PGW may be allocated.

At the center of a communication, the PGW is able to allow connections between IP addresses alone, because it is only at this point that the GTP header is remove.

Embodiments of the present specification use a dynamic routing protocol between the PGW(s), SGW(s) and eNB to provide mapping of TEID to allocated IP address. In an embodiment, open shortest path first (OSPF)'s opaque link state advertising (LSA) features are used to advertise and distribute these mappings. LSA is a basic communication means of the OSPF routing protocol for the Internet Protocol (IP). It communicates the router's local routing topology to all other local routers in the same OSPF area. OSPF is designed for scalability, so some LSAs are not flooded out on all interfaces, but only on those that belong to the appropriate area. In this way detailed information can be kept localized, while summary information is flooded to the rest of the network. This enables every core network component to be aware of all IP addresses in use on the network, and the TEIDs associated with them.

As IP sessions are created between end devices, the next network element compares the destination IP address seen in the lower layer of the S1-U or S5 frame, and determines whether the destination IP address is in a TEID currently known by that element. For example, in the case of two UEs on the same eNB, the eNB would know the TEID allocated to the destination IP, check to see if that TEID exists in the local S1-U routing table, and if so, “cut through” the IP session. In the case of an eNB, this would be a direct IP connection not requiring GTP.

In the case of two devices on eNBs connected to the same SGW, the SGW may be responsible for cutting through the media, adding the correct TEID to the egress session. As both S1-U and S5 run over UDP, there is no “session” and data may be statelessly directed to the remote device.

The disclosure also allows local IP devices to be placed on the eNB or SGW. A dummy TEID may be advertised into the OSPF system, indicating the node with the local IP device as the destination. Return traffic may then be sent back to the originating device using the same TEID/IP look-up. This is beneficial for scenarios where local content caches are required.

Mobility is retained using the S1/S5 link as on a mobility event the OPSF network advertises reachability through a new TEID, in which case the cut through may be terminated.

One issue that is raised by this is “lawful” versus “unlawful” intercept. In other words, how can the network know that the interception of the packets is an authorized action rather than malware. In one embodiment, lawful intercept (LI) is handled by distributing to all devices a blacklist of devices under surveillance. Network devices are then expected to not cut through media to or from those devices. In this way, all LI traffic continues to the same destination path, typically the PGW, without modification to the existing LI architecture.

In the case of interactive services such as voice over LTE (VoLTE) sessions, there may be a delay introduced to the cut through media session, proportional to the saved round-trip time. This helps to ensure that if a session cut through at an eNB needs to be cut through at the SGW or at the PGW, the number of lost packets due to the extra round-trip time is minimized. For example, embodiments of VoLTE typically require the loss of no more than one voice frame in a 20 ms packetization system.

A system and method for optimizing traffic in a packet core network will now be described with more particular reference to the attached FIGURES. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiment many have different advantages, and no particular advantage is necessarily required of any embodiment.

In some embodiments, hyphenated reference numerals, such as 10-1 and 10-2, may be used to refer to multiple instances of the same or a similar item 10, or to different species of a genus 10.

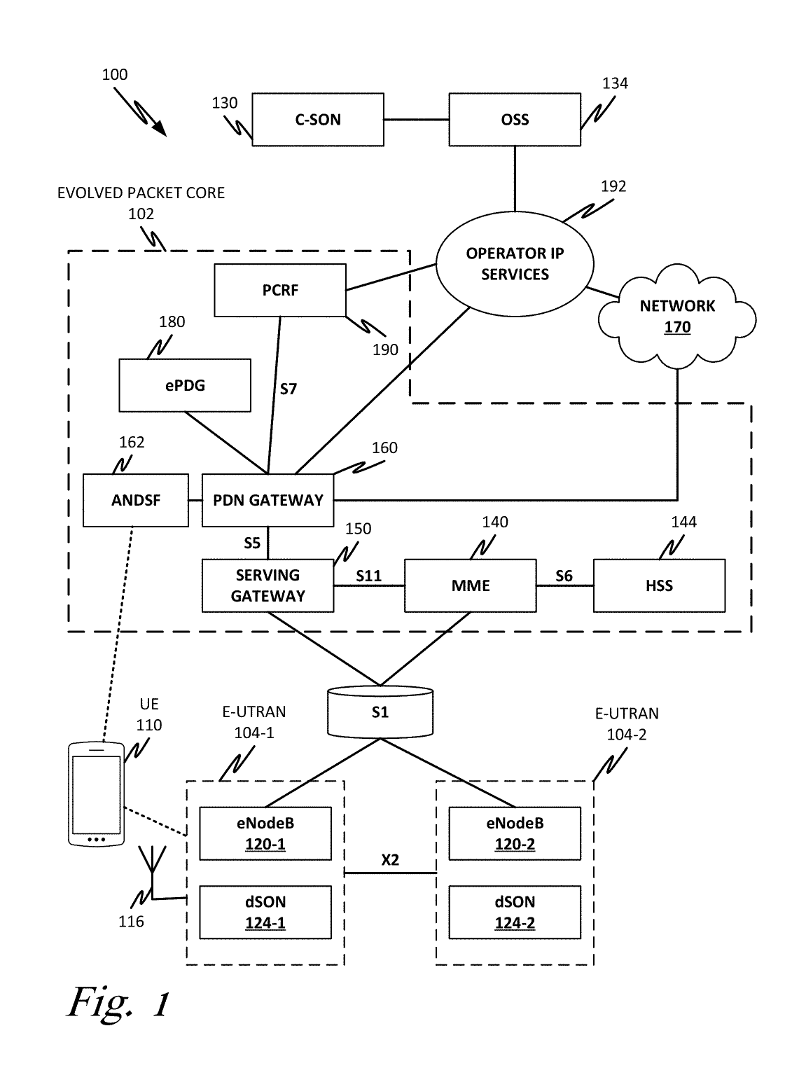

FIG. 1 is a block diagram of a mobile network 100 according to one or more examples of the present specification. In this specific example, a fourth-generation long-term evolution (4G LTE, or simply LTE) network is disclosed by way of non-limiting example. In certain embodiments, LTE is used primarily for data transfer, so that mobile network 100 may also provide, in addition to the elements shown here, structure for handling voice communication, which may communicatively couple to a public-switched telephone network (PSTN). In some cases, voice over LTE (VoLTE) may also be provided. It should also be noted that LTE is disclosed only as one possible embodiment of the teachings of this specification, and that the teachings may be relevant to other telecommunication structures now in existence or later developed, and the scope of this specification is intended to encompass such structures where applicable.

In this example, mobile network 100 includes user equipment (UE) 110 communicatively coupled, for example via a wireless antenna 116, to an evolved UMTS radio access network (E-UTRAN) 104. UE 110 may initiate a data transaction or session with E-UTRAN 104-1, referred to herein as a “data call.” E-UTRAN 104 communicatively couples to an evolved packet core (EPC) 102, for example via wired connections. E-UTRAN 104 may include, by way of non-limiting example, an evolved NodeB (eNB) 120, which acts as a wireless base station, and a distributed self-organizing network (dSON) controller 124.

In various embodiments, these functions may be provided by dedicated servers or appliances. In other embodiments, select functions may be provided in virtual environments, such as a rack-mounted server providing various functions in a hypervisor. In a general sense, the various UE-class devices, server-class devices, network functions, may be generally classified as “computing devices.” As used throughout this specification, a computing device includes any electrical or electronic device based on the Von Neumann architecture, including a processor with a control unit and logic unit, and a memory. In that context, it should be understood that the Von Neumann architecture may be provided either as a physical device, or as a virtual machine or hypervisor running at one or more layers of abstraction from the physical hardware.

In this example, two E-UTRANS 104-1 and 104-2 are disclosed to illustrate the mobile nature of the network. UE 110 may move, for example, as a user carrying UE 110 moves. As UE 110 moves farther away from E-UTRAN 104-1, its signal to E-UTRAN 104 will attenuate. If UE 110 simultaneously moves closer to E-UTRAN 104-2, its signal with E-UTRAN 104-2 will become stronger When UE 110 has moved such that it gets a stronger signal to E-UTRAN 104-2 than to E-UTRAN 104-1, E-UTRAN 104-1 may hand off the data call to E-UTRAN 104-2, so that E-UTRAN 104-2 seamlessly continues handling the data call.

Handoff may be handled over the X2 interface. In this example, two classes of signals are passed within mobile network 100: voice, data, and call signals (referred to herein as the “user plane” signals) and control signals (referred to herein as the “control plane” signals). X2 provides both a control plane interface and a user plane interface, and in an embodiment is a wired connection between the two E-UTRANs 104. The protocol structure of the S1 control plane is based on stream control transmission protocol/internet protocol (SCTP/IP). The user plane provides a protocol structure based on general packet radio service (GPRS) tunneling protocol/user datagram protocol/IP (GTP/UDPS/IP). On the user plane, a transport bearer may be identified by an IP address and one or more GTP tunneling endpoint IDs (TEID). X2 operates as a meshed interface, meaning that a plurality of eNBs 120 may all be linked together. Properly configured, X2 helps to minimize packet loss as UE 110 hands off from one E-UTRAN 104 to another. Specifically, when the data call is handed off, unsent or unacknowledged packets stored in the old eNB 120's queues can be forwarded or tunneled to the new eNB 120 via the X2 interface.

E-UTRANs 104 communicatively couple to an EPC 102 via an S1 interface. As with the X2 interface, S1 provides both a control plane and a user plane, configured similarly to the respective X2 control plane and user plane. In an embodiment, the S1 application protocol (S1-AP) is mapped directly on top of SCTP.

In this example, EPC 102 includes a serving gateway (SGW) 150, a mobility management entity (MME) 140, a home subscriber server (HSS) 144, a packet data network (PDN) gateway 160, an evolved packet data gateway (ePDG) 180, and policy and charging rules function (PCRF) 190. EPC 102 for its part may communicatively couple, via appropriate interfaces, to a public network such as internet 170, or to operator IP services 192.

When UE 110 is performing data operations, such as web applications, web surfing, e-mail, or other network operations, UE 120 connects to Internet 170 via mobile network 100. In one example scenario, user plane signals originate from UE 110 and are passed to E-UTRAN 104. Within E-UTRANs 104, user plane signals are first received by eNB 120 (or other similar base station), which interfaces with EPC 102 to handle the data call.

As a wireless local area network (WLAN) access point (WAP), eNB 120 supports Layer 1 and Layer 2 of the E-UTRAN orthogonal frequency division multiplexing (OFDM) physical interface. Advantageously, eNBs 120 may directly connect to a network router, thus simplifying network architecture. eNB 120 may support certain legacy features related to physical layer procedures for transmitting and receiving, including modulation and demodulation, and channel encoding and decoding. eNB 120 may also provide radio resource control and radio mobility management for processing handovers.

EPC 102 provides several functional blocks to provide various support functions. These are described herein by way of non-limiting example only.

MME 140 provides control functions to EPC 102. MME 140 provides idle mode UE paging and tagging procedures, including retransmissions. MME 140 also provides bearer activation and deactivation support, and may choose an appropriate SGW 150 for UE 110 when UE 110 initially attaches to EPC 102 via E-UTRAN 104. After attachment, MME 140 authenticates UE 110 via HSS 144.

Non Access Stratum (NAS) signaling terminates at MME 140, and MME 140 is also responsible for generating and allocating a temporary identity for UE 110. MME 140 then verifies the authorization of UE 110 to resources on the service provider's public land mobile network (PLMN), and enforces roaming restrictions on UE 110. MME 140 is also a terminal endpoint for ciphering/integrity protection for NAS signaling, and handles security key management. MME 140 also supports lawful signal interception. MME 140 also provides control plane functions for mobility between LTE and 2G/3G networks with the S3 interface terminating at MME 140 from, for example, a 3G serving GPRS support node (SGSN). Finally, MME 140 terminates the Sha interface of HSS 144 for roaming UEs.

HSS 144 is, in an embodiment, a database server to provide home location register (HLR) and authentication center (AuC) services. The functions of the HSS include call and session establishment support, user authentication, and access authorization, by way of non-limiting example.

In an embodiment, HLR stores and updates a user subscription information database. This may include the following, by way of nonlimiting example:
a. User identification and addressing, including the International Mobile Subscriber Identity (IMSI), Mobile Subscriber ISDN Number (MSISDN), and/or mobile telephone number.
b. User profile information, including subscriptions and quality of service (QoS) data.

AuC generates security data from user identity keys, and provides the data to at least the HLR, and as necessary, to other functional blocks.

SGW 150 forwards user data packets, while also acting as the mobility anchor for the user plane during inter-eNodeB handovers and as the anchor for mobility between LTE and other 3GPP technologies (terminating S4 interface and relaying the traffic between 2G/3G systems and PDN Gateway 150). When UE 110 is idle, SGW 150 terminates the downlink data path and triggers paging when downlink data arrives for UE 110. SGW 150 may also store UE contexts including parameters of the IP bearer service and network internal routing information. It also performs replication of the user traffic in case of lawful interception.

PDN Gateway 160 provides connectivity from UE 110 to external packet data networks (PDNs) and provides both an entry point and exit point for UE traffic. UE 110 may simultaneously connect to more than one PDN Gateway 150, and thus may access multiple PDNs. In an example, PDN Gateway 150 provides policy enforcement, packet filtering on a per-user basis, charging support, lawful interception, and packet screening, by way of nonlimiting example.

Access Network Discovery and Selection Function (ANDSF) 162 helps UE 110 discover non-3GPP access networks, such as Wi-Fi or WIMAX, that can be used in addition to the LTE network for data communication. ANDSF 160 may provide UE 110 with rules policing the connection to such networks. ANDSF 160 may provide the following to UE, by way of non-limiting example:
a. Inter-system mobility policy (ISMP)—network selections rules for when UE 110 has no more than one active access network connection (e.g., either LTE or Wi-Fi).
b. Inter-system routing policy (ISRP)—network selection rules for when UE 110 has potentially more than one active access network connection (e.g., both LTE and Wi-Fi). In this case, UE 110 may employ IP flow mobility, multiple-access PDN connectivity (MAPCON), or non-seamless Wi-Fi offload according to policy and user preferences.
c. Discovery information—a list of networks that may be available in the vicinity of UE 110, and information to help UE 110 connect to these networks.

ANDSF 162 may communicate with the UE 110 over the S14 reference point, which in some embodiments is specific to ANDSF.

PCRF 190 provides, in an embodiment, both policy decision functions (PDF) and charging rules functions (CRF).

PDF makes policy decisions. Specifically, when an IP multimedia subsystem (IMS) is set up, session initiation protocol (SIP) data include media requirements, which the terminal and proxy call session control function (P-CSCF) may exchange between themselves. During the session establishment process, the PDF may also receive those requirements from the P-CSCF and make decisions based on network operator rules. These may include, by way of non-limiting example:
a. Allowing or rejecting a media request.
b. Using new or existing PDP context for an incoming media request.
c. Checking allocation of resources against authorized resource usage.

The CRF provides operator-defined charging rules applicable to each service data flow. The CRF selects the relevant charging rules based on information provided by the P-CSCF, such as Application Identifier, Type of Stream (audio, video, etc.), or Application Data Rate, by way of nonlimiting example.

ePDG 180 secures data transmission with a UE 110 connected to EPC 102 over an untrusted, non-3GPP access. For this purpose, the ePDG acts as a termination node of IPsec tunnels established with UE 110.

Network 170 may be any suitable network or combination of one or more networks operating on one or more suitable networking protocols, including for example, a local area network, an intranet, a virtual network, a wide area network, a wireless network, a cellular network, or the Internet (optionally accessed via a proxy, virtual machine, or other similar security mechanism) by way of nonlimiting example. Network 170 may also include one or more servers, firewalls, routers, switches, security appliances, antivirus servers, or other useful network devices. In this illustration, network 170 is shown as a single network for simplicity, but in some embodiments, network 170 may include a large number of networks, such as one or more enterprise intranets connected to the Internet.

Operator IP services 192 include services provided by an operator of EPC 102. Operator IP services 192 may include, or may communicatively couple to an operations support system (OSS) 132. OSS 132 provides hardware and software for monitoring, controlling, analyzing, and managing EPC 102.

Advantageously, LTE provides for self-organizing networks (SONs) (also sometimes called a self-optimizing network, which is used interchangeably). SON provides automation methods to facilitate planning, configuring, managing, optimizing, and healing a network such as EPC 102 and E-UTRAN 104.

SON may be provided in different flavors, including for example centralized SON (C-SON) 130, distributed SON (dSON) 124, and in some cases hybrid SON (hSON).

C-SON 130 provides centralized higher-level network control, with increased coordination between nodes for functions such as load balancing across a wide geographic area. In contrast, dSON 124 provides a distributed, peer-to-peer control function, in which each E-UTRAN network wirelessly receives reported parameters from other E-UTRANs, and makes autonomous decisions based on those reports. hSON (not shown in this illustration) provides a hybrid solution in which some functions are centralized and others are distributed.

Advantageously, SON provides useful functions such as:
a. Self-configuration. In a self-configuration network, new base stations are automatically configured and integrated into the network, and new features on a base station are also seamlessly integrated. When a new base station is introduced into the network and powered on, it is immediately recognized and registered by the network. The neighboring base stations then automatically adjust to provide the required coverage and capacity, as well as to avoid the interference.
b. Self-Optimization. Base station such as eNBs 120 may provide configuration parameters intended to control and/or optimize their behavior. Based on observations of both eNB 120 itself, and measurements at UE 110 or elsewhere, a SON may automatically reconfigure these parameters to enhance network efficiency. In another embodiment, SON provides automatic neighbor relations (ANR), and optimizes random access parameters or mobility robustness. In yet another embodiment, SON switches off some number of base stations at night to conserve power. These base stations may be selected to ensure that full coverage is still provided in a coverage area. Neighboring base station may reconfigure appropriate parameters to ensure full coverage and adjust to the changed network topology. If a sudden spike in demand occurs, one or more sleeping base stations may wake up almost instantaneously. This may realize significant power savings without sacrificing network
c. Self-Healing. If a network node (such as an eNB 120) goes down, self-healing helps to mitigate the effect of the failure on the overall network. For example a SON may adjust parameters and algorithms in adjacent eNBs 120 so that they can continue to provide service to the failed eNB 120. This is in contrast to legacy networks, where substantial time and resources may need to be committed to repairs when a base station fails. With self-healing networks, the network may automatically and nearly-instantaneously self-adjust with little or no service interruption.

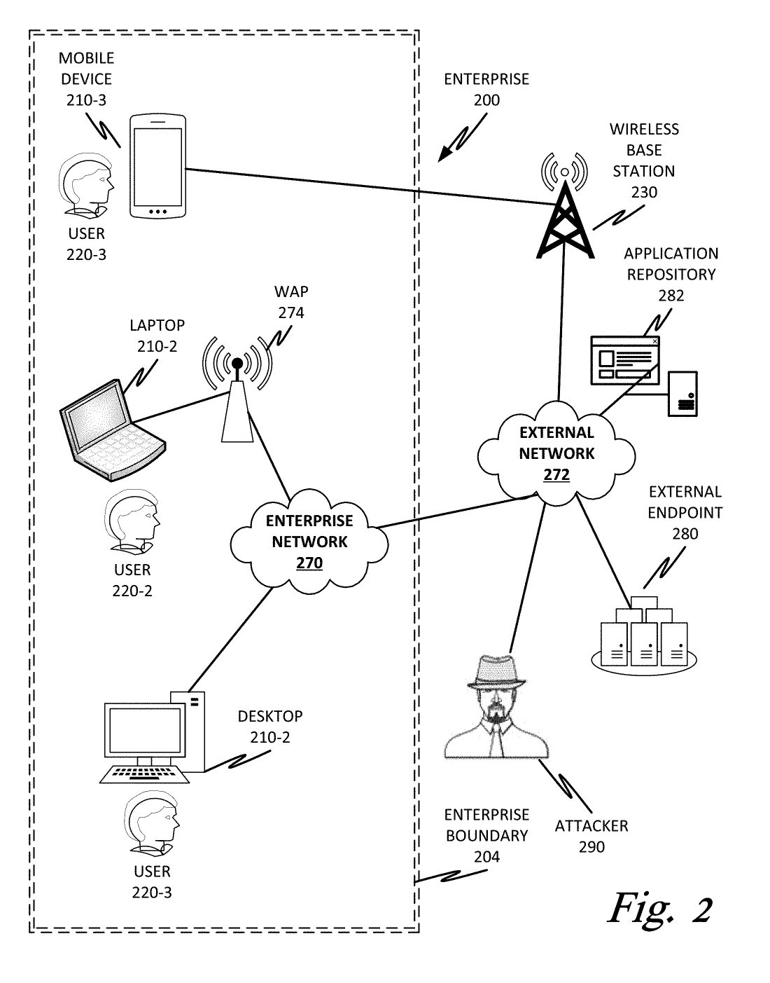

FIG. 2 is a network-level diagram of a networked enterprise 200 according to one or more examples of the present specification. Enterprise 200 may be any suitable enterprise, including a business, agency, nonprofit organization, school, church, or home/family network, by way of non-limiting example. In the example of FIG. 2, a plurality of users 220 operate a plurality of endpoints or client devices 210, which may be UE-class devices. Specifically, user 220-1 operates desktop computer 210-1. User 220-2 operates laptop computer 210-2. And user 220-3 operates mobile device 210-3.

Each computing device may include an appropriate operating system, such as Microsoft Windows, Linux, Android, Mac OSX, Apple iOS, Unix, or similar. Some of the foregoing may be more often used on one type of device than another. For example, desktop computer 210-1, which in one embodiment may be an engineering workstation, may be more likely to use one of Microsoft Windows, Linux, UNIX, or Mac OSX. Laptop computer 210-2, which is usually a portable off-the-shelf device with fewer customization options, may be more likely to run Microsoft Windows or Mac OSX. Mobile device 210-3 may be more likely to run Android or iOS. However, these examples are for illustration only, and are not intended to be limiting.

Client devices 210 may be communicatively coupled to one another and to other network resources via enterprise network 270. By way of example, laptop computer 210-2 connects to enterprise network 270 via wireless access point (WAP) 274, which may be for example a Wi-Fi router. WAP 274 may operate on a wireless protocol such as IEEE 802.11 standards or similar. Mobile device 210-3 may connect to an E-UTRAN 104, and via proxy services (for example) may access resources on enterprise network 270.

Enterprise network 270 may be any suitable network or combination of one or more networks operating on one or more suitable networking protocols, including for example, a local area network, an intranet, a virtual network, a wide area network, a wireless network, a cellular network, or the Internet (optionally accessed via a proxy, virtual machine, or other similar security mechanism) by way of nonlimiting example. Enterprise network 270 may also include one or more servers, firewalls, routers, switches, security appliances, antivirus servers, or other useful network devices, along with appropriate software. In this illustration, enterprise network 270 is shown as a single network for simplicity, but in some embodiments, enterprise network 270 may include a large number of networks, such as one or more enterprise intranets connected to the Internet. Enterprise network 270 may also provide access to an external network 272, such as the Internet.

Networked enterprise 200 may encounter a variety of “network objects” on the network. A network object may be any object that operates on, interacts with, or is conveyed via enterprise network 270. In one example, objects may be broadly divided into hardware objects, including any physical device that communicates with or operates via the network, and software objects.

Networked enterprise 200 may communicate across enterprise boundary 204 with external network 272. Enterprise boundary 204 may represent a physical, logical, or other boundary. External network 272 may include, for example, websites, servers, network protocols, and other network-based services. In one example, network objects on external network 272 include E-UTRAN 104, EPC 102, an application repository 230, an external endpoint 280, and an attacker 290. External endpoint 280 may be a website that one or more users 220 want to legitimately access, or may provide a remote service to users 220. It may be a goal for enterprise 200 to provide access to desirable services, such as service provider 280, while excluding malicious objects such as attacker 290, or malware that may infect enterprise network 270.

In some cases, networked enterprise 200 may provide policy directives that restrict the types of applications that can be installed from application repository 230. Thus, application repository 230 may include software that is not negligently developed and is not malware, but that is nevertheless against policy. For example, some enterprises restrict installation of entertainment software like media players and games. Thus, even a secure media player or game may be unsuitable for an enterprise computer. A security administrator may be responsible for distributing a computing policy consistent with such restrictions and enforcing it on client devices 210.

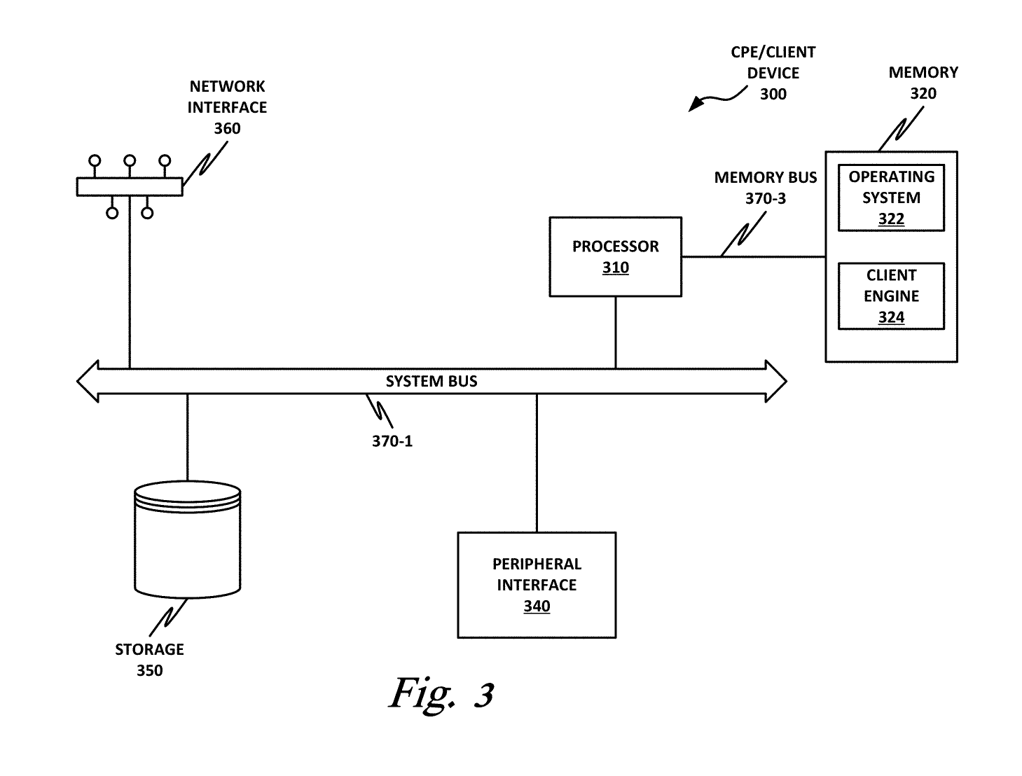

FIG. 3 is a block diagram of computing device 300 according to one or more examples of the present specification. Computing device 300 may be any suitable computing device. In various embodiments, a “computing device” may be or comprise, by way of non-limiting example, a computer, workstation, server, mainframe, embedded computer, embedded controller, embedded sensor, personal digital assistant, laptop computer, cellular telephone, IP telephone, smart phone, tablet computer, convertible tablet computer, computing appliance, network appliance, receiver, wearable computer, handheld calculator, or any other electronic, microelectronic, or microelectromechanical device for processing and communicating data. In certain embodiments, user equipment 110 of FIG. 1 and client devices 210 of FIG. 2 may all be examples of computing devices 300.

Computing device 300 includes a processor 310 connected to a memory 320, having stored therein executable instructions for providing an operating system 322 and at least software portions of a UE engine 324. Other components of computing device 300 include a storage 350, network interface 360, and peripheral interface 340. This architecture is provided by way of example only, and is intended to be non-exclusive and non-limiting. Furthermore, the various parts disclosed are intended to be logical divisions only, and need not necessarily represent physically separate hardware and/or software components. Certain computing devices provide main memory 320 and storage 350, for example, in a single physical memory device, and in other cases, memory 320 and/or storage 350 are functionally distributed across many physical devices. In the case of virtual machines or hypervisors, all or part of a function may be provided in the form of software or firmware running over a virtualization layer to provide the disclosed logical function. In other examples, a device such as a network interface 360 may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, microcode, programmable logic, or objects that can coordinate to achieve a logical operation.

In an example, processor 310 is communicatively coupled to memory 320 via memory bus 370-3, which may be for example a direct memory access (DMA) bus by way of example, though other memory architectures are possible, including ones in which memory 320 communicates with processor 310 via system bus 370-1 or some other bus. Processor 310 may be communicatively coupled to other devices via a system bus 370-1. As used throughout this specification, a “bus” includes any wired or wireless interconnection line, network, connection, bundle, single bus, multiple buses, crossbar network, single-stage network, multistage network or other conduction medium operable to carry data, signals, or power between parts of a computing device, or between computing devices. It should be noted that these uses are disclosed by way of non-limiting example only, and that some embodiments may omit one or more of the foregoing buses, while others may employ additional or different buses.

In various examples, a “processor” may include any combination of logic elements, including by way of non-limiting example a microprocessor, digital signal processor, field-programmable gate array, graphics processing unit, programmable logic array, application-specific integrated circuit, or virtual machine processor. In certain architectures, a multi-core processor may be provided, in which case processor 310 may be treated as only one core of a multi-core processor, or may be treated as the entire multi-core processor, as appropriate. In some embodiments, one or more co-processor may also be provided for specialized or support functions.

Processor 310 may be connected to memory 320 in a DMA configuration via DMA bus 370-3. To simplify this disclosure, memory 320 is disclosed as a single logical block, but in a physical embodiment may include one or more blocks of any suitable volatile or non-volatile memory technology or technologies, including for example DDR RAM, SRAM, DRAM, cache, L1 or L2 memory, on-chip memory, registers, flash, ROM, optical media, virtual memory regions, magnetic or tape memory, or similar. In certain embodiments, memory 320 may comprise a relatively low-latency volatile main memory, while storage 350 may comprise a relatively higher-latency non-volatile memory. However, memory 320 and storage 350 need not be physically separate devices, and in some examples may represent simply a logical separation of function. It should also be noted that although DMA is disclosed by way of non-limiting example, DMA is not the only protocol consistent with this specification, and that other memory architectures are available.

Storage 350 may be any species of memory 320, or may be a separate device. Storage 350 may include one or more non-transitory computer-readable mediums, including by way of non-limiting example, a hard drive, solid-state drive, external storage, redundant array of independent disks (RAID), network-attached storage, optical storage, tape drive, backup system, cloud storage, or any combination of the foregoing. Storage 350 may be, or may include therein, a database or databases or data stored in other configurations, and may include a stored copy of operational software such as operating system 322 and software portions of UE engine 324. Many other configurations are also possible, and are intended to be encompassed within the broad scope of this specification.

Network interface 360 may be provided to communicatively couple computing device 300 to a wired or wireless network. A “network,” as used throughout this specification, may include any communicative platform operable to exchange data or information within or between computing devices, including by way of non-limiting example, an ad-hoc local network, an internet architecture providing computing devices with the ability to electronically interact, a plain old telephone system (POTS), which computing devices could use to perform transactions in which they may be assisted by human operators or in which they may manually key data into a telephone or other suitable electronic equipment, any packet data network (PDN) offering a communications interface or exchange between any two nodes in a system, or any local area network (LAN), metropolitan area network (MAN), wide area network (WAN), wireless local area network (WLAN), virtual private network (VPN), intranet, or any other appropriate architecture or system that facilitates communications in a network or telephonic environment.

UE engine 324, in one example, is operable to carry out computer-implemented methods as described in this specification. UE engine 324 may include one or more non-transitory computer-readable mediums having stored thereon executable instructions operable to instruct a processor to provide a UE engine. As used throughout this specification, an “engine” includes any combination of one or more logic elements, of similar or dissimilar species, operable for and configured to perform one or more methods provided by UE engine 324. Thus, UE engine 324 may comprise one or more logic elements configured to provide methods as disclosed in this specification. In some cases, UE engine 324 may include a special integrated circuit designed to carry out a method or a part thereof, and may also include software instructions operable to instruct a processor to perform the method. In some cases, UE engine 324 may run as a “daemon” process. A “daemon” may include any program or series of executable instructions, whether implemented in hardware, software, firmware, or any combination thereof, that runs as a background process, a terminate-and-stay-resident program, a service, system extension, control panel, bootup procedure, BIOS subroutine, or any similar program that operates without direct user interaction. In certain embodiments, daemon processes may run with elevated privileges in a “driver space,” or in ring 0, 1, or 2 in a protection ring architecture. It should also be noted that UE engine 324 may also include other hardware and software, including configuration files, registry entries, and interactive or user-mode software by way of non-limiting example.

In one example, UE engine 324 includes executable instructions stored on a non-transitory medium operable to perform a method according to this specification. At an appropriate time, such as upon booting computing device 300 or upon a command from operating system 322 or a user 120, processor 310 may retrieve a copy of UE engine 324 (or software portions thereof) from storage 350 and load it into memory 320. Processor 310 may then iteratively execute the instructions of UE engine 324 to provide the desired method.

In certain embodiments, UE engine 324 need not be aware of the optimizations introduced in this specification. Rather, UE engine 324 may simply communicate according to its normal method, and remain agnostic of tunneling cut- throughs performed upstream, such as at the eNB or SGW. In other embodiments, UE engine 324 may be provided with specialized interfaces or abilities that help UE 110 take advantage of the optimizations.

Peripheral interface 340 may be configured to interface with any auxiliary device that connects to computing device 300 but that is not necessarily a part of the core architecture of computing device 300. A peripheral may be operable to provide extended functionality to computing device 300, and may or may not be wholly dependent on computing device 300. In some cases, a peripheral may be a computing device in its own right. Peripherals may include input and output devices such as displays, terminals, printers, keyboards, mice, modems, network controllers, sensors, transducers, actuators, controllers, data acquisition buses, cameras, microphones, speakers, or external storage by way of non-limiting example.

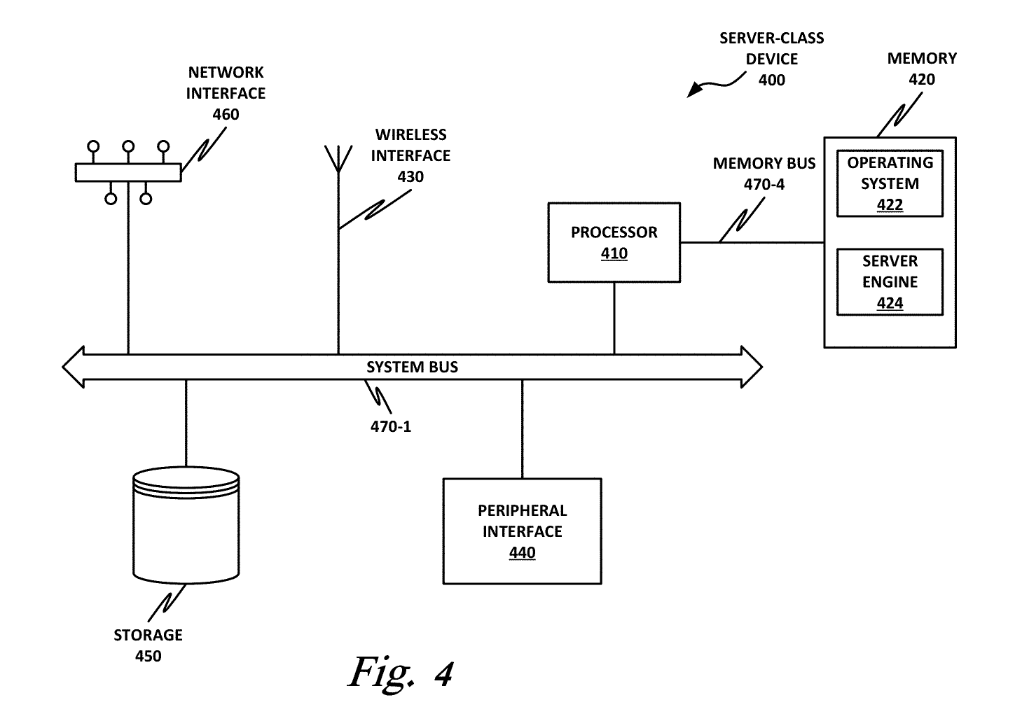

FIG. 4 is a block diagram of a server-class device 400 according to one or more examples of the present specification. Server-class device 400 may be any suitable computing device, as described in connection with FIG. 3. In general, the definitions and examples of FIG. 3 may be considered as equally applicable to FIG. 4, unless specifically stated otherwise. Server-class device 400 is described herein separately to illustrate that in certain embodiments, logical operations according to this specification may be divided along a client-server model, wherein computing device 300 provides certain localized tasks, while server-class device 400 provides certain other centralized tasks. In one embodiment, all of the logical devices of FIG. 1 and FIG. 2, except user equipment 120 and endpoints 210, may be server-class devices. These devices may be physical, or may be implemented in some cases in a virtualized environment, such as a hypervisor.

Server-class device 400 includes a processor 410 connected to a memory 420, having stored therein executable instructions for providing an operating system 422 and at least software portions of a server engine 424. Other components of server-class device 400 include a storage 450, network interface 460, and peripheral interface 440. As described in FIG. 3, each logical block may be provided by one or more similar or dissimilar logic elements.

In an example, processor 410 is communicatively coupled to memory 420 via memory bus 470-3, which may be for example a direct memory access (DMA) bus. Processor 410 may be communicatively coupled to other devices via a system bus 470-1.

Processor 410 may be connected to memory 420 in a DMA configuration via DMA bus 470-3, or via any other suitable memory configuration. As discussed in FIG. 3, memory 420 may include one or more logic elements of any suitable type.

Storage 450 may be any species of memory 420, or may be a separate device, as described in connection with storage 250 of FIG. 2. Storage 450 may be, or may include therein, a database or databases or data stored in other configurations, and may include a stored copy of operational software such as operating system 422 and software portions of server engine 424.

Network interface 460 may be provided to communicatively couple server-class device 400 to a wired or wireless network, and may include one or more logic elements as described in FIG. 2.

Server engine 424 is an engine as described in FIG. 3 and, in one example, includes one or more logic elements operable to carry out computer-implemented methods as described in this specification. Software portions of server engine 424 may run as a daemon process.

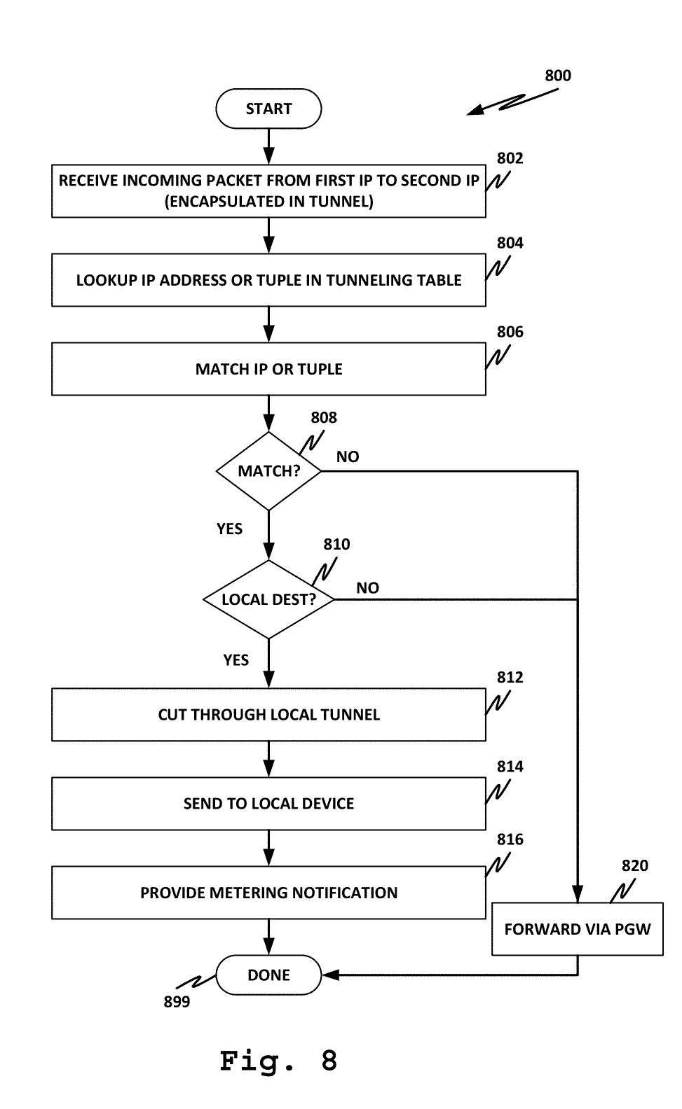

Server engine 424 may include one or more non-transitory computer-readable mediums having stored thereon executable instructions operable to instruct a processor to provide a UE engine. At an appropriate time, such as upon booting server-class device 400 or upon a command from operating system 222 or a user 120 or security administrator 150, processor 410 may retrieve a copy of server engine 424 (or software portions thereof) from storage 450 and load it into memory 420. Processor 410 may then iteratively execute the instructions of server engine 424 to provide the desired method. In particular, server engine 424 may be configured to provide a method such as method 800 of FIG. 8.

Peripheral interface 440 may be configured to interface with any auxiliary device that connects to server-class device 400 but that is not necessarily a part of the core architecture of server-class device 400. A peripheral may be operable to provide extended functionality to server-class device 400, and may or may not be wholly dependent on server-class device 400. Peripherals may include, by way of non-limiting examples, any of the peripherals disclosed in FIG. 3.

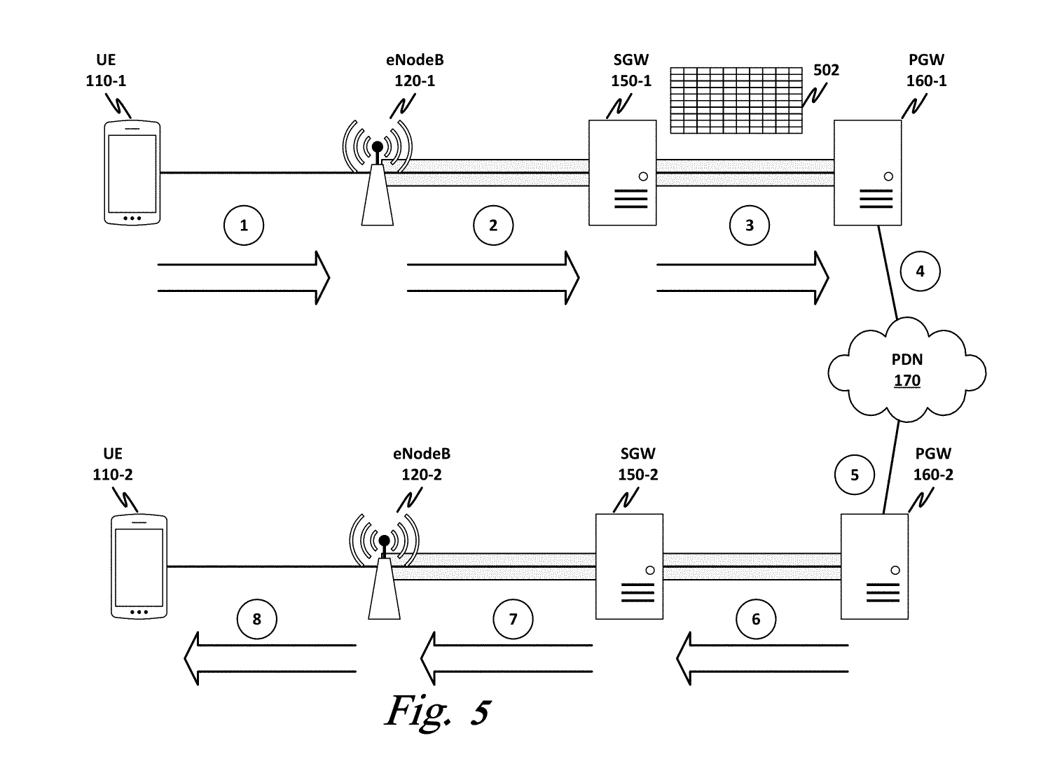

FIG. 5 is a block diagram illustrating tunneling according to GPRS Tunneling Protocol (GTP) according to one or more examples of the specification.

GTP should be understood herein as an example of a tunneling protocol that may be compatible with embodiments of this specification. In other embodiments, other tunneling protocols may be used. GTP also need not be treated as a single, monolithic protocol. Rather, in an example, GTP is a group of IP-based communications protocols for carrying GPRS data within other networks, such as GSM, UMTS and LTE networks.

Embodiments of GTP may be broken out into several groups, such as GTP-C, GTP-U, and GTP′ (GTP prime).

GTP-C may be used within the GPRS core network to signal between GPRS support nodes (GGSN) and serving GPRS support nodes (SGSN). Thus, for example, the SGSN may activate a session on a user's behalf, deactivate the session, adjust quality of service parameters, or update a session for a newly-arrived subscriber coming from a different SGSN.

GTP-U is used for carrying user data within the GPRS core network and between the radio access network and the core network.

GTP′ (GTP prime) functions independently of GTP-C and GTP-U, though it uses the same message structure. GTP′ can be used for carrying charging data from the charging data function (CDF) of the GSM or UMTS network to the charging gateway function (CGF). Generally, this means carrying data from many individual network elements such as the GGSNs to a centralized computer that delivers the charging data more conveniently to the network network operator for billing purposes.

Embodiments of GTP may be used with either UDP or TCP.

When an LTE UE device sends a packet, eNB 120 establishes a tunnel to PGW 160. eNB 120 then sends to PGW 160 via the GTP tunnel. Thus, in existing implementations, all IP packets that a UE sends are delivered via the UE>eNB>SGW>PGW path, regardless of the specified destination. A return packet, regardless of the source, traverses the same path in reverse.

In the example of FIG. 5, assume that UE 110-1 and UE 110-2 are in close physical proximity, but on separate networks. At (1), UE 110-1 (with an IP address of 4.4.4.4) sends an IP packet, with its destination IP address set to the IP address of UE 110-2, in this case 8.8.8.8. UE 110-1 delivers the packet to eNB 120-1 via its radio interface. The original packet may be as follows:

| | |
|---|---|
| IP Header: SRC = 4.4.4.4, | IP PAYLOAD |
| DEST = 8.8.8.8 | |

For ease of discussion, this original, unmodified packet may be considered “tunneling level 0,” where the “tunnel” is the raw IP packet.

At (2), after receiving the packet from the UE 110-1, eNB 120-1 prepends a GTP tunnel header, which in an embodiment includes three separate headers, namely a GTP header, a UDP header, and an IP header for GTP tunneling. eNB 120 then forwards the packet to SGW 150-1. The packet may now appear as follows:

(The data are shown in multiple rows only because of size constraints. The shaded gray fields represent the header data added by eNB 120-1.)

If the only network between eNB 120-1 and SGW 150-1 is an IP routing network, the routing network performs routing based on the destination IP address of the packet (i.e., the IP address of SGW 150-1, which is the address included in the outer IP header), and delivers the IP packet to the SGW 150-1.

Note also that a TEID has been added now. This may be considered “tunneling level 1.” THE tunnel UL (uplink) S1-TEID (because S1 is the link between eNB and SGW) has been “wrapped” around the original IP packet.

At (3), after receiving the packet from the eNB 120-1, SGW 150-1 modifies its GTP header and IP header (outer IP header) as follow:

| | | |
|---|---|---|
| OUT IP HDR: | UDP Header | GTP Header: |
| SRC = SGW, DEST = PGW | | TEID = UL S5-TEID |
| IP Header: SIP = UE, | IP PAYLOAD | |
| DIP = 8.8.8.8 | | |

Again, the shaded gray area is the header added by the SGW (GTP tunnel header). Note that now the SRC IP is the IP address of SGW 150-1, and the DEST IP is the IP address of PGW 160.

A new tunnel UL S5-TEID (because S5 is the interface between SGW and PGW) has also been added. This may be considered “tunneling level 2.” Using pipes as an analogy, the original packet is the innermost “pipe,” the eNB to SGW tunnel is the next-level pipe, and the SGW to PGW tunnel is the outermost pipe.

SGW 150-1 delivers the packet to PGW 160-1.

At (4), PGW 160-1 removes all three headers (Outer IP header/UDP header/GTP header) from the packet and delivers the original packet to a public data network (PDN) 170 (e.g., the Internet).

Since UE 110-2 is also on an LTE network, the IP address of 110-2 (8.8.8.8) sits behind PGW 160-2. Thus, at (5), PDN 170 delivers the packet to PGW 160-2. The header is as follows:

| | |
|---|---|
| IP Header: SRC = 4.4.4.4, | IP PAYLOAD |
| DEST = 8.8.8.8 | |

The process now reverses so that the packet can be delivered to UE 110-2.

At (6), PGW 160-2 tunnels the packet to SGW 150-2 with the following header:

| | | |
|---|---|---|
| OUT IP HDR: | UDP Header | GTP Header: |
| SRC = PGW, DEST = SGW | | TEID = DL S5-TEID |
| IP Header: SIP = UE, | IP PAYLOAD | |
| DIP = 8.8.8.8 | | |

The tunnel is now downlink (DL) S5-TEID, because S5 is the link between PGW 160-2 and SGW 150-2.

At (7), SGW 150-2 tunnels the packet to eNB 120-2 with the following header:

This tunnel is DL S1-TEID, because it is a downlink, and S1 is the interface between SGW 150-2 and eNB 120-2.

Finally, at 8, eNB 120-2 strips away the extra headers, and delivers the packet to UE 110-2.

At least one unique GTP tunnel is generated for each UE 110. Thus, for example, if 100 UEs 110 are connected to eNB 120, 100 different GTP tunnels will be generated. To distinguish the various tunnels from one another, each network device (e.g., eNB 120 and SGW 150) assigns a unique TEID to each tunnel, and creates a tunneling table 502. Although tunneling tables of a type are used in existing systems, tunneling table 502 includes enhancements, such as a list of the tunnels (including TEID) created at that level, and how those tunnels map to various devices, and the IP address for each tunnel. Thus, the example TEIDs above may in operation actually be numeric identifiers, rather than the descriptive text TEIDs shown above. However, as indicated above, tunnels are unidirectional. A tunnel serves only as an uplink or a downlink, not as both.

With tunneling table 502, network devices can distinguish UEs 110 from one another by looking up their TEIDs in tunneling table 502. While in the tunnels, packets to or from UEs 110 do not have traditional IP addresses. Rather, the TEID serves as a proxy for the IP address.

Again, note that although UE 110-1 and UE 110-2 may be physically right next to each other, the data packet from UE 110-1 to UE 110-2 has traversed possibly many miles of network infrastructure. This may be necessary because, for example, the subscribers use different wireless carriers.

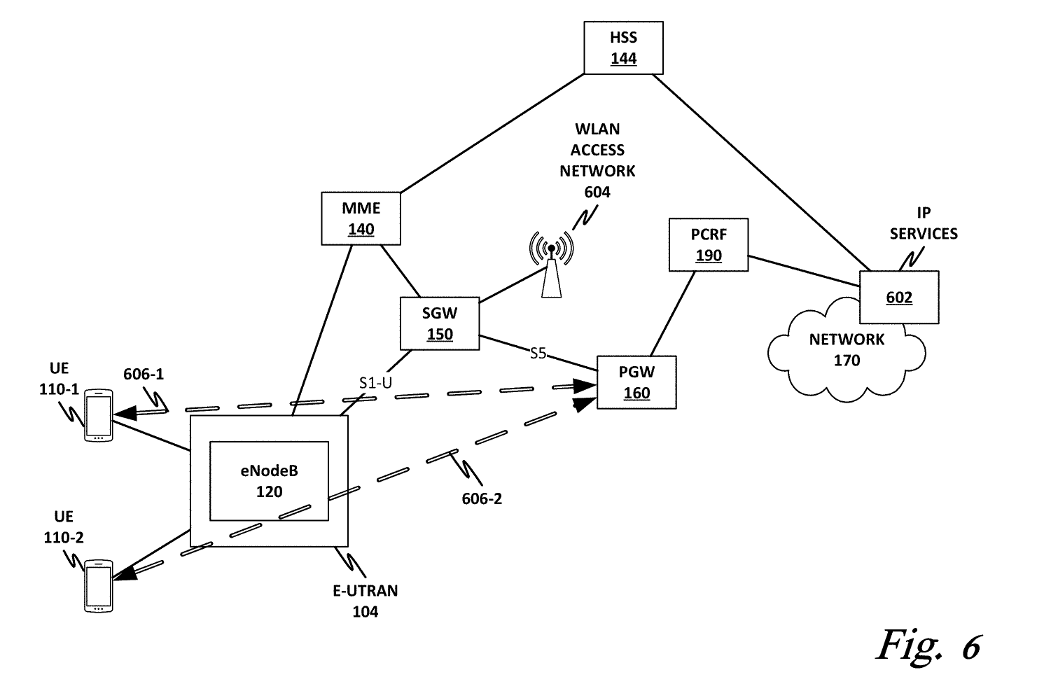

But note that in the example of FIG. 6, UE 110-1 and UE 110-2 are not only physically proximate, but also reside on the same wireless (e.g., LTE) network. In this case, UEs 110 are connected to the same eNB 120. But when UE 110-1 sends data to UE 110-2, the packet must first follow tunnel 606-1 all the way to PGW 160. PGW 160 then sends the packet via tunnel 606-2 back down to UE 110-2.

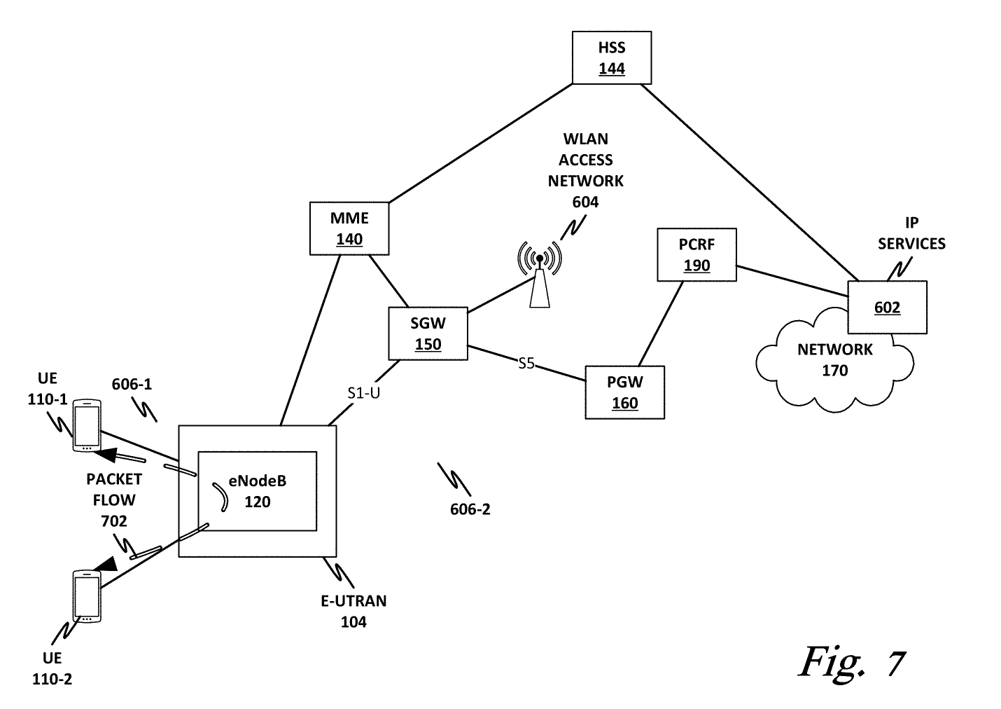

As illustrated in FIG. 7, greater efficiency can be realized by providing a packet flow that passes directly through eNB 120, so that the packet can go from UE 110-1 to UE 110-2 with only a single intermediary hop. This can be accomplished by “cutting the tunnel,” and short circuiting the route straight through eNB 120.

Note that it is not always necessary or desirable to reroute packets in this way. For example, if the packet is a simple text message or other lightweight packet, the extra overhead of cutting the tunnel may not be worth the time savings. But if UE 110-1 is trying to stream higher-bandwidth data, such as multimedia, to UE 110-2, then substantial savings may be realized by cutting the tunnel. Thus, in certain embodiments, before traffic is short circuited, packets may optionally be screened according to an IP match (e.g., all packets from IP1 to IP2 are short circuited), or a SRC/DEST/PROTOCOL tuple (e.g., packets from IP1 to IP2 are short circuited if they match a particular protocol, such as a multimedia protocol).

When UE 110-1 and UE 110-2 connect to EPC 102, each EU 110 is given an IP address from an appropriate pool. Uplink and downlink tunnels with associated TEIDs may also be created for each. eNB 120 and SGW 150 store the tunneling data in their respective tunneling tables 502

Regardless of which eNB 120 or SGW 150 the UE moves to, the same IP address may be used, but new tunnels between the eNB 120 and SGW 150 and/or between SGW 150 and PGW 160 may be allocated.

At the center of a communication between UE 110-1 and UE 110-2, PGW 160 is able to allow connections between the raw IP addresses, because at this point the GTP headers are removed.

But if both UEs 110 are connected to a common eNB 120, or even to different eNBs 120 on a common SGW 150, routing overhead can be saved by short-circuiting through the nearest common path to the two UEs 110.

Embodiments of the present specification use a dynamic routing protocol between the PGW(s) 160, SGW(s) 150, and eNB 120 to provide mapping of TEIDs to allocated IP address. In an embodiment, OSPF's opaque link state advertising (LSA) feature is used to advertise and distribute these mappings, which may be stored in each devices tunneling table 502. This allows network device to be aware of all IP addresses in use on the network, as well as the TEIDs associated with them.

As IP sessions are created between end devices, the next-closest network element compares the destination IP address seen in the lower layer of the S1-U (for eNB) or S5 (for SGW) frame, and determines whether the destination IP address is in a TEID currently known by that element. For example, in the case of two UEs on the same eNB, the eNB would know the TEID allocated to the destination IP, check to see if that TEID exists in the local S1-U routing table, and if so, “cut through” the IP session. In the case of an eNB, this would be a direct IP connection not requiring GTP.

In the case of two devices on eNBs connected to the same SGW, the SGW may be responsible for cutting through the media, and adding the correct TEID to the egress session. As both S1-U and S5 run over UDP, there is no “session” and data may be statelessly directed to the remote device.

The also allows local IP devices to be placed on the eNB or SGW. A dummy TEID may be advertised into the OSPF system, indicating the node with the local IP device as the destination. Return traffic may then be sent back to the originating device using the same TEID/IP look-up. This is beneficial for scenarios where local content caches are required.

Mobility is retained using the S1/S5 link as on a mobility event the OPSF network advertises reachability through a new TEID, in which case the cut through may be terminated.

In one embodiment, lawful intercept (LI) is handled by distributing to all devices a blacklist of devices under surveillance. Devices that are blacklisted may, for example, be excluded from tunneling table 502. Note that “blacklisted” in this context does not necessarily imply a “security blacklist,” but rather that the packet (or tunnel) is blacklisted from cut through. Network devices are then expected to not cut through media to or from those devices. In this way, all LI traffic continues to the same destination path, typically the PGW, without modification to the existing LI architecture. In some cases, LI also includes providing an upstream notification (for example, up to PGW 160) of the data used, such as for billing purposes. In one example, a new interface may be defined at least in part for the purpose of providing such upstream billing notifications.

In the case of interactive services such as voice over LTE (VoLTE) sessions, there may be a delay introduced to the cut through media session, proportional to the saved round-trip time. This helps to ensure that if a session cut through at an eNB needs to be cut through at the SGW or at the PGW, the number of lost packets due to the extra round-trip time is minimized. For example, embodiments of VoLTE typically require the loss of no more than one voice frame in a 20 ms packetization system.

FIG. 8 is a flow chart of a method 800 of performing tunneling cut through according to examples of the present specification.

In block 802, a network device (such as an eNodeB or SGW) receives an incoming packet from a first IP address, with a destination of a second IP address. The packet may be encapsulated in a tunnel so that the source and/or destination IP address are not immediately visible.

In block 804, the device looks up the TEID in tunneling table 502 to find a matching IP address or other identifier.

In block 806, the device may optionally attempt to match the IP address against a screening criterion. For example, this may indicate that certain IP addresses are not to be cut through. (Alternatively, the absence of a TEID on the tunneling table may imply that the tunnel is not to be cut through, such as if the packet is “blacklisted” from tunnel cutting.) Alternatively, certain IP addresses may be actively flagged for cutting or not cutting, or certain IP address and protocol combinations may be flagged for cutting (such as multimedia streams being flagged for tunnel cutting). Many other screening criteria are possible.

In decision block 808, the device determines whether the packet matches any screening criteria. If not, then in block 820, it forwards the packet normally via PGW 160, and in block 899 the method is done.

If the packet matches any screening criteria, then in block 810, the device determines whether the destination is “local.” In this context, local means that the destination device can be reached by some path that is shorter than the traditional path that traverses the PGW. That may mean that the two devices are connected to a common eNodeB, or to different eNodeBs connected to a common SGW. These configurations are provided by way of nonlimiting example. Many other connection configurations are possible. Stated differently, a destination is “local” if there is a common routing point that is closer than the traditional PGW point.

If the destination device is not a local destination, then in block 820, the packet is routed normally via the PGW, and in block 899, the method is done.

If the destination device is local, then in block 812, the device cuts through the GTP tunnel according to the methods discussed herein. This may include rewriting an egress (downlink) tunnel, or otherwise modifying the packet so that it is routed correctly on the downlink.

In block 814, the device forwards the packet to the local destination device with the new downlink information in place. At the eNodeB, this may involve simple TCP/IP routing. At the SGW, this may involve forwarding down to a destination eNodeB with a rewritten GTP header. Other embodiments are also possible.

In block 816, the device may provide an upstream metering notification, which may be used for example for billing. This may be provided over existing channels, or a new or dedicated interface may be provided for such metering notifications. In embodiments where metering cut-through traffic is not desirable or necessary, this operation may be skipped.

In block 899, the method is done.

The foregoing outlines features of several embodiments so that those skilled in the art may better understand the aspects of the present disclosure. In the foregoing, references to “an embodiment,” “certain embodiments,” “an example,” “one or more examples,” and similar are not intended to necessarily refer to the same embodiment. Some embodiments may contain one or more such features and exclude others, while other embodiments may include or exclude different features. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

The particular embodiments of the present disclosure may readily include a system on chip (SOC) central processing unit (CPU) package. An SOC represents an integrated circuit (IC) that integrates components of a computer or other electronic system into a single chip. It may contain digital, analog, mixed-signal, and radio frequency functions: all of which may be provided on a single chip substrate. Other embodiments may include a multi-chip-module (MCM), with a plurality of chips located within a single electronic package and configured to interact closely with each other through the electronic package. In various other embodiments, the digital signal processing functionalities may be implemented in one or more silicon cores in Application Specific Integrated Circuits (ASICs), Field Programmable Gate Arrays (FPGAs), and other semiconductor chips. Furthermore, in various embodiments, the processors, memories, network cards, buses, storage devices, related peripherals, and other hardware elements described herein may be realized by a processor, memory, and other related devices configured by software or firmware to emulate or virtualize the functions of those hardware elements.

In example implementations, at least some portions of the processing activities outlined herein may also be implemented in software. In some embodiments, one or more of these features may be implemented in hardware provided external to the elements of the disclosed figures, or consolidated in any appropriate manner to achieve the intended functionality. The various components may include software (or reciprocating software) that can coordinate in order to achieve the operations as outlined herein. In still other embodiments, these elements may include any suitable algorithms, hardware, software, components, modules, interfaces, or objects that facilitate the operations thereof.

Additionally, some of the components associated with described microprocessors may be removed, or otherwise consolidated. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, equipment options, etc.

Any suitably-configured processor component can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof. In operation, processors may store information in any suitable type of non-transitory storage medium (for example, random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. Further, the information being tracked, sent, received, or stored in a processor could be provided in any database, register, table, cache, queue, control list, or storage structure, based on particular needs and implementations, all of which could be referenced in any suitable timeframe. Any of the memory items discussed herein should be construed as being encompassed within the broad term ‘memory.’ Similarly, any of the potential processing elements, modules, and machines described herein should be construed as being encompassed within the broad term ‘microprocessor’ or ‘processor.’

Computer program logic implementing all or part of the functionality described herein is embodied in various forms, including, but in no way limited to, a source code form, a computer executable form, and various intermediate forms (for example, forms generated by an assembler, compiler, linker, or locator). In an example, source code includes a series of computer program instructions implemented in various programming languages, such as an object code, an assembly language, or a high-level language such as OpenCL, Fortran, C, C++, JAVA, or HTML for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

In the discussions of the embodiments above, the capacitors, buffers, graphics elements, interconnect boards, clocks, DDRs, camera sensors, dividers, inductors, resistors, amplifiers, switches, digital core, transistors, and/or other components can readily be replaced, substituted, or otherwise modified in order to accommodate particular circuitry needs. Moreover, it should be noted that the use of complementary electronic devices, hardware, non-transitory software, etc. offer an equally viable option for implementing the teachings of the present disclosure.

In one example embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In another example embodiment, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

In an example, there is disclosed a computing apparatus, comprising: a network interface to communicatively couple the computing device to a public data network gateway (PGW); a long term evolution (LTE) function engine to provide an LTE function; and a tunneling cut through engine, including at least a processor and a memory, to: receive an incoming packet; lookup a destination of the incoming packet on a tunneling table; determine that the destination of the incoming packet is reachable via a route shorter than traversing the PGW; and route the packet via the shorter route.

There is also disclosed an example, wherein the tunneling table includes a tunneling endpoint identifier (TEID) and an associated internet protocol (IP) address.

There is also disclosed an example, wherein routing the packet via the shorter route comprises cutting through a tunnel for the packet.

There is also disclosed an example, wherein the tunneling cut through engine is further to add an egress tunnel to the packet.

There is also disclosed an example, wherein the tunneling cut through engine is further to screen the packet according to an address or a source, destination, protocol tuple.

There is also disclosed an example, wherein the tunneling cut through engine is further to: determine that the tunneling table does not include an entry for the destination; and route the packet via the PGW.

There is also disclosed an example, wherein the tunneling cut through engine is further to: receive data for mapping a tunneling endpoint identifier (TEID) to an associated internet protocol (IP) address; update the tunneling table with the TEID and IP address.

There is also disclosed an example, wherein the apparatus is a serving gateway (SGW).

There is also disclosed an example, wherein the apparatus is an eNodeB.

There is also disclosed an example of one or more tangible, non-transitory computer-readable storage mediums having stored thereon executable instructions to: communicatively couple to a public data network gateway (PGW); provide an LTE function; and provide a tunneling cut through engine to: receive an incoming packet; lookup a destination of the incoming packet on a tunneling table; determine that the destination of the incoming packet is reachable via a route shorter than traversing the PGW; and route the packet via the shorter route.

There is also disclosed an example, wherein the tunneling table includes a tunneling endpoint identifier (TEID) and an associated internet protocol (IP) address.

There is also disclosed an example, wherein routing the packet via the shorter route comprises cutting through a tunnel for the packet.

There is also disclosed an example, wherein the tunneling cut through engine is further to add an egress tunnel to the packet.

There is also disclosed an example, wherein the tunneling cut through engine is further to screen the packet according to an address or a source, destination, protocol tuple.

There is also disclosed an example, wherein the tunneling cut through engine is further to: determine that the tunneling table does not include an entry for the destination; and route the packet via the PGW.

There is also disclosed an example, wherein the tunneling cut through engine is further to: receive data for mapping a tunneling endpoint identifier (TEID) to an associated internet protocol (IP) address; update the tunneling table with the TEID and IP address.

There is also disclosed an example of a method of operating a long-term evolution (LTE) network device, comprising: communicatively coupling to a public data network gateway (PGW); providing an LTE function; and receiving an incoming packet; looking up a destination of the incoming packet on a tunneling table including a tunneling endpoint identifier (TEID) and an internet protocol (IP) address; determining that the destination of the incoming packet is reachable via a route shorter than traversing the PGW; and routing the packet via the shorter route, comprising cutting through a tunnel for the packet.

There is also disclosed an example, further comprising adding an egress tunnel to the packet.

There is also disclosed an example, further comprising: determining that the tunneling table does not include an entry for the destination; and routing the packet via the PGW.

There is also disclosed an example, further comprising: receiving data for mapping a tunneling endpoint identifier (TEID) to an associated internet protocol (IP) address; updating the tunneling table with the TEID and IP address.

There is further disclosed an example of providing a tunneling cut through engine comprising performing any or all of the operations of the preceding examples.

There is further disclosed an example of a computer readable medium having stored thereon executable instructions to perform the method.

There is further disclosed an example of an apparatus comprising means to perform the method.

There is further disclosed an example where the means comprise a processor and a memory.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 (pre-AIA) or subsection (f) of 35 U.S.C. section 112 (post-AIA) as it exists on the date of the filing hereof unless the words “means for” or “steps for” are specifically used in the particular claims; and (b) does not intend, by any statement in the specification, to limit this disclosure in any way that is not otherwise reflected in the appended claims.

What is claimed is:

1. A computing apparatus, comprising:
a network interface to communicatively couple the computing device to a public data network gateway (PGW);
a long term evolution (LTE) function engine to provide an LTE function; and
a tunneling cut through engine, including at least a processor and a memory, to:
receive an incoming packet;
lookup a destination of the incoming packet on a tunneling table;
determine that the destination of the incoming packet is reachable via a route shorter than traversing the PGW; and
route the packet via the shorter route.

2. The computing apparatus of claim 1, wherein the tunneling table includes a tunneling endpoing identifier (TEID) and an associated internet protocol (IP) address.

3. The computing apparatus of claim 1, wherein routing the packet via the shorter route comprises cutting through a tunnel for the packet.

4. The computing apparatus of claim 3, wherein the tunneling cut through engine is further to add an egress tunnel to the packet.

5. The computing apparatus of claim 1, wherein the tunneling cut through engine is further to screen the packet according to an address or a source, destination, protocol tuple.

6. The computing apparatus of claim 1, wherein the tunneling cut through engine is further to:
determine that the tunneling table does not include an entry for the destination; and
route the packet via the PGW.

7. The computing apparatus of claim 1, wherein the tunneling cut through engine is further to:
receive data for mapping a tunneling endpoing identifier (TEID) to an associated internet protocol (IP) address;
update the tunneling table with the TEID and IP address.

8. The computing apparatus of claim 1, wherein the apparatus is a serving gateway (SGW).

9. The computing apparatus of claim 1, wherein the apparatus is an eNodeB.

10. One or more tangible, non-transitory computer-readable storage mediums having stored thereon executable instructions to:
communicatively couple to a public data network gateway (PGW);
provide an LTE function; and
provide a tunneling cut through engine to:
receive an incoming packet;
lookup a destination of the incoming packet on a tunneling table;
determine that the destination of the incoming packet is reachable via a route shorter than traversing the PGW; and
route the packet via the shorter route.

11. The one or more tangible, non-transitory computer-readable storage mediums of claim 10, wherein the tunneling table includes a tunneling endpoing identifier (TEID) and an associated internet protocol (IP) address.

12. The one or more tangible, non-transitory computer-readable storage mediums of claim 10, wherein routing the packet via the shorter route comprises cutting through a tunnel for the packet.

13. The one or more tangible, non-transitory computer-readable storage mediums of claim 12, wherein the tunneling cut through engine is further to add an egress tunnel to the packet.

14. The one or more tangible, non-transitory computer-readable storage mediums of claim 10, wherein the tunneling cut through engine is further to screen the packet according to an address or a source, destination, protocol tuple.

15. The one or more tangible, non-transitory computer-readable storage mediums of claim 10, wherein the tunneling cut through engine is further to:
determine that the tunneling table does not include an entry for the destination; and
route the packet via the PGW.

16. The one or more tangible, non-transitory computer-readable storage mediums of claim 10, wherein the tunneling cut through engine is further to:
receive data for mapping a tunneling endpoing identifier (TEID) to an associated internet protocol (IP) address;
update the tunneling table with the TEID and IP address.

17. A method of operating a long-term evolution (LTE) network device, comprising:
communicatively coupling to a public data network gateway (PGW);
providing an LTE function; and
receiving an incoming packet;
looking up a destination of the incoming packet on a tunneling table including a tunneling endpoint identifier (TEID) and an internet protocol (IP) address;
determining that the destination of the incoming packet is reachable via a route shorter than traversing the PGW; and
routing the packet via the shorter route, comprising cutting through a tunnel for the packet.

18. The method of claim 17, further comprising adding an egress tunnel to the packet.

19. The method of claim 17, further comprising:
determining that the tunneling table does not include an entry for the destination; and
routing the packet via the PGW.

20. The method of claim 17, further comprising:
receiving data for mapping a tunneling endpoing identifier (TEID) to an associated internet protocol (IP) address;
updating the tunneling table with the TEID and IP address.
